(19) United States
(12) Patent Application Publication
(10) Pub. No.: US 2020/0049240 A1
(43) Pub. Date: Feb. 13, 2020

(54) BALL SCREW DRIVE

(71) Applicant: Schaeffler Technologies AG & Co. KG, Herzogenaurach (DE)

(72) Inventor: Stephan Ruffershöfer, Dachsbach (DE)

(73) Assignee: Schaeffler Technologies AG & Co. KG, Herzogenaurach (DE)

(21) Appl. No.: 16/343,028

(22) PCT Filed: Nov. 13, 2017
(86) PCT No.: PCT/DE2017/100954

§ 371 Date: Apr. 18, 2019

(30) Foreign Application Priority Data
Nov. 21, 2016 (DE) 102016222894.3

(51) Int. Cl. F16H 25/22; F16H 55/22

(52) U.S. Cl. CPC F16H 25/2204; F16H 2025/2481; F16H 55/22

(57) ABSTRACT

A ball screw drive having a hollow spindle is designed for ease of manufacture. A threaded outer part is joined to an inner sleeve by a press fit joint. The inner sleeve may be made of a softer material than the outer part. The inner sleeve includes a collar that projects beyond the outer part. The collar includes at least one stop element and may have teeth. The stop elements may interact with a stop contour of a ball screw nut and/or with anti-rotation contours of a housing.

### CROSS-REFERENCE TO RELATED APPLICATIONS

This application is the U.S. National Phase of PCT Appln. No. PCT/DE2017/100954 filed Nov. 13, 2017, which claims priority to DE 102016222894.3 filed Nov. 21, 2016, the entire disclosures of which are incorporated by reference herein.

### TECHNICAL FIELD

The disclosure relates to a ball screw drive which has a threaded spindle designed as a hollow spindle.

### BACKGROUND

A ball screw drive is generally constructed from a threaded spindle and a ball screw nut interacting therewith, wherein balls roll as rolling elements between the threaded spindle and the ball screw nut. If the threaded spindle is configured as a hollow spindle, a further component, in particular an additional spindle, can be accommodated in the threaded spindle.

DE 202 07 122 U1 discloses a device for linear stroke adjustment which is intended to be usable as a foot of a piece of furniture and comprises three telescopic tubes capable of moving relative to one another. The device according to DE 202 07122 U1 has a plurality of spindles, some of which are designed as hollow spindles. The hollow spindles are electrically driven by means of spur gearing.

Further drive units, likewise provided for furniture, having screw drives which each have a hollow spindle are described in documents DE 200 00 487 U1 and DE 20 2009 007 347 U1, for example.

DE 202 14 566 U1 discloses an electric-motor linear drive having a threaded spindle designed as a hollow spindle and having a ball screw nut assembled from a plurality of nut parts. This linear drive is also supposed to be suitable for use in furniture.

Screw drives, especially ball screw drives, are used in general to convert a rotary motion into a linear motion or vice versa. In this case, either the threaded spindle or the ball screw nut can act as a rotating part, while the other part in each case is secured in a manner which allows translation and is generally secured against rotation.

A ball screw drive having a ball screw nut with an integrated anti-rotation safeguard is known from DE 10 2014 219 256 A1, for example. In this case, the ball screw nut additionally has a circumferential stop on the nut.

A recirculating ball screw arrangement having stop contours is also known from EP 2 573 418 B1. In this case, a plurality of stops in the form of a primary ball nut stop and of a secondary recirculating ball screw stop is provided.

Ball screw drives are also used in motor vehicle engineering. By way of example, attention is drawn in this context to DE 10 2011 118 365 A1, which relates to an electronically controllable brake actuating system.

### SUMMARY

It is the underlying object of the disclosure to specify a ball screw drive having a hollow spindle which is developed further than the prior art, especially in terms of manufacturing technology.

This object is achieved by a ball screw drive having a threaded spindle, which is designed as a hollow spindle and is of multi-part construction. In this case, an outer part of the threaded spindle, said outer part having a thread, is connected to an inner sleeve without additional components, in particular by means of a press fit joint.

The threaded spindle can be a single-start or multi-start threaded spindle. In both cases, no additional connecting elements are required to produce a permanently secure joint between the inner sleeve and the outer part.

In addition to a press fit joint, joints produced by welding or clinching may also be mentioned as possible designs for a permanent torque-transmitting joint between the inner sleeve and the outer part. Torque transmission between said parts can also be made possible or additional retention provided by the shaping of the outer part and the inner sleeve, e.g. in the form of polygon contours or teeth.

The inner sleeve and the outer part are not necessarily manufactured from the same material. On the contrary, embodiments in which the inner sleeve is manufactured from a softer material than the outer part are advantageous. In particular, the inner sleeve has a lower surface hardness than the outer part or at least the circumferential surface thereof which describes the thread. To produce the inner sleeve, forming methods such as deep drawing are suitable, in particular. It is likewise possible to employ forming methods in the production of the outer part. The thread of the outer part can be produced by roller forming, for example. Machining methods are also suitable for the production or partial working of the outer part.

The advantage of the multi-part construction of the threaded spindle consists especially in the fact that it is particularly simple to provide additional functions by means of the inner part. Such additional functions can be performed, for example, by a collar which is an integral part of the inner sleeve and projects beyond the cylindrical hollow outer part at the end. A stop element or a plurality of stop elements can be formed on the collar. In the simplest case, stops are formed as radially outward-oriented extensions of the collar. It is likewise possible in each case for the stops to have the shape of a bent tongue which adjoins the collar and points in the axial direction of the threaded spindle. In particular, a stop projection of this kind extended in the axial direction of the ball screw drive can have a multiple function, interacting both with a stop contour of a ball screw nut and with an anti-rotation contour of a housing to which the threaded spindle is connected.

In alternative embodiments, toothing is formed on the collar. Such toothing can serve either to prevent rotation or to drive the threaded spindle in rotation.

Irrespective of the presence and of the design of a collar, the inner sleeve can have an end surface segment, i.e. a radially inward-oriented flange, which can be used as an end stop. Adjoining a central aperture situated in the end surface segment, radially toward the outside, there can be an aperture on the circumference of the end surface segment. A circumferential aperture of this kind can be used as a cable opening, for example.

The inner sleeve of the threaded spindle can be of single- or multi-part construction. In the case of multi-part construction, a parting plane in which two individual parts of the inner sleeve abut one another can lie in a plane normal to the axis of rotation of the ball screw drive, for example. In this case, a first individual part of the inner sleeve can be provided with a collar, for example, while an inward-oriented flange, i.e. end surface, adjoins the second individual part of the inner sleeve. In addition or as an alternative to the press fitting of the individual parts of the inner sleeve in the outer part of the threaded spindle, some other joint suitable for the transmission of a torque is in principle also possible between the various parts of the threaded spindle, e.g. a joint brought about by means of knurling. This applies both to a multi-part inner sleeve and to a single-part inner sleeve.

The ball screw drive is particularly suitable for an actuator in a motor vehicle, e.g. for a chassis actuator or for an electromechanically actuated brake. The ball screw drive is likewise suitable for stationary applications, e.g. in building technology.

### BRIEF DESCRIPTION OF THE DRAWINGS

A number of embodiment examples are explained in greater detail below with reference to a drawing. In the drawing:

FIG. 1 shows a multi-part threaded spindle in a perspective illustration,

FIG. 2 shows the threaded spindle according to FIG. 1 in a sectioned view,

FIGS. 3 and 4 show an outer part and an inner sleeve of another threaded spindle

FIG. 5 shows a threaded spindle in an exploded view,

FIG. 6 shows another design of a threaded spindle in a perspective view,

FIG. 7 shows an inner sleeve of the threaded spindle shown in FIG. 6,

FIGS. 8 and 9 show the threaded spindle according to FIG. 6 with an associated ball screw nut,

FIGS. 10 and 11 show a screw drive according to FIG. 8 and an arrangement comprising a housing in various states of assembly.

### DETAILED DESCRIPTION

Unless stated otherwise, the following explanations relate to all the embodiment examples. Parts which correspond to one another or in principle act in the same way are in each case provided with the same reference signs.

A ball screw drive 1 is constructed from a threaded spindle 2, namely a hollow spindle, and a ball screw nut 3. Rolling elements, namely balls, which roll between a thread 7 of the threaded spindle 2 and the ball screw nut 3, are not illustrated in the figures. For the sake of simplicity, a ball recirculation element is likewise not illustrated.

The threaded spindle 2 is assembled from two spindle parts 5, 6, namely an outer part 5, on the circumferential surface of which the thread 7 is formed, and an inner sleeve 6. Inner sleeve 6 has significantly thinner walls than the outer part 5. The inner sleeve 6 is connected firmly to the outer part 5 by means of a press fit joint. At one end of the threaded spindle 2, the inner sleeve 6 projects slightly beyond the outer part 5; the outer part 5 projects beyond the inner sleeve 6 at the opposite end.

A collar 8 of the inner sleeve 6, which abuts the end of the outer part 5, can be seen at that end of the threaded spindle 2 at which the inner sleeve 6 projects beyond the outer part 5. Adjoining the collar 8 in the axial direction is a press fit surface 19, by means of which the press fit is established between the inner sleeve 6 and the outer part 5. As an option, there are further press fit surfaces, which are not visible in the figures.

At the end of the inner sleeve 6 remote from the collar 8, the inner sleeve has an annular end surface segment 10, i.e. a radially inward-oriented flange. The end surface segment 10, which acts as an end stop, delimits a circular central aperture 11 and is interrupted at its circumference by an aperture 12, which is also referred to as a circumferential aperture and can be used, in particular, as a cable opening.

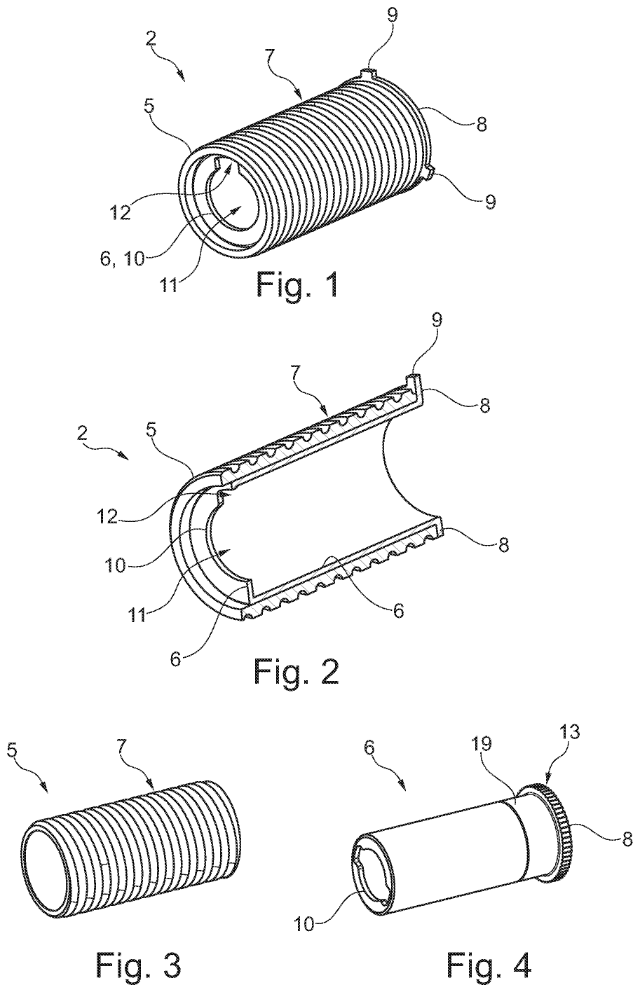

In the embodiment example shown in FIGS. 1 and 2, a plurality of stop elements 9 pointing radially precisely outward are formed on the collar 8, it being possible to use said stop elements to secure the threaded spindle 2 against rotation or as a stop for a ball screw nut (not illustrated here), for example.

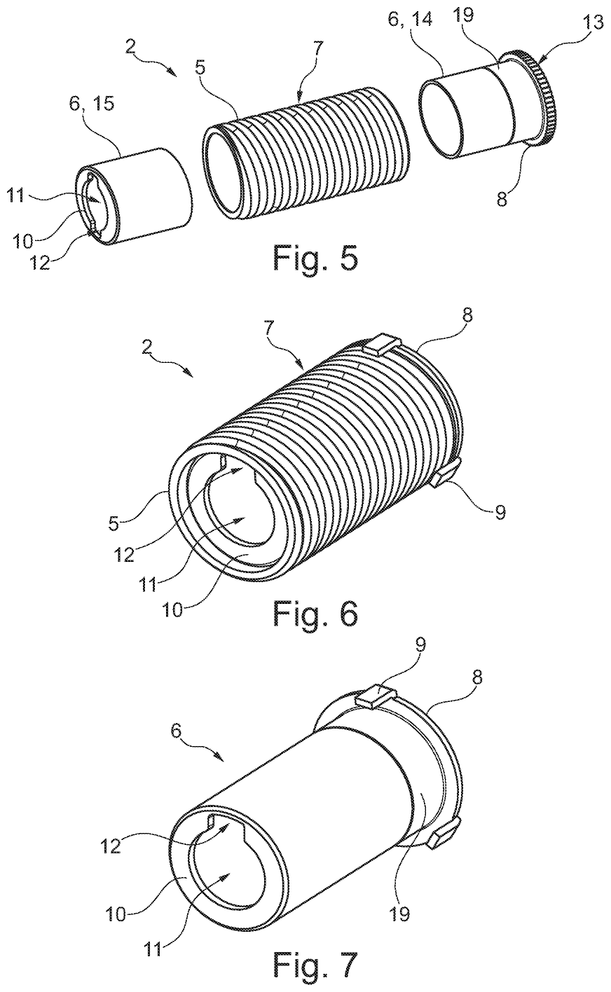

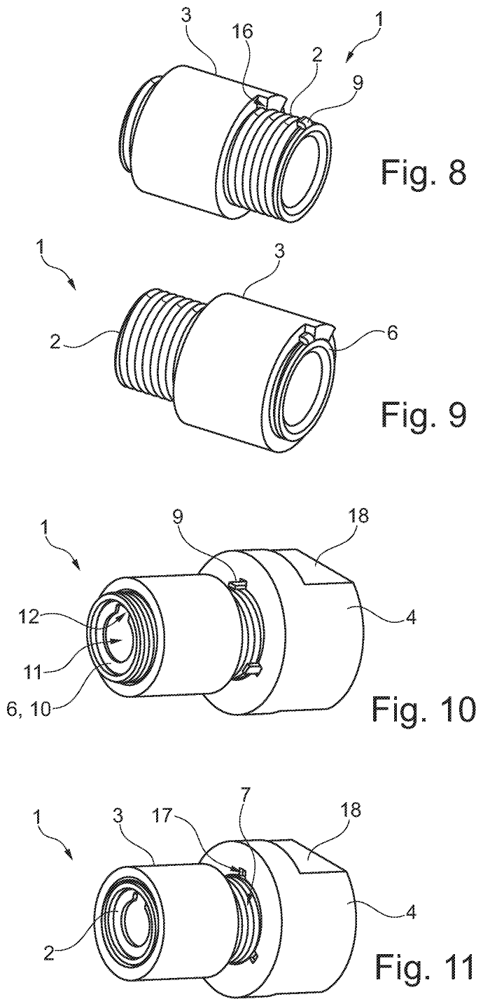

In the embodiment example shown in FIGS. 3 and 4, the collar 8 is not provided with individual stop elements but with toothing 13. By means of the toothing 13, the entire threaded spindle 2 can be driven, wherein a torque-transmitting joint between the inner sleeve 6 and the outer part 5 of the threaded spindle 2 is established by means of the press fit, which is implemented with the aid of the press fit surface 19. Additional anti-rotation mechanisms, which may be positive-locking, between the inner sleeve 6 and the outer part 5 are not required. Thus, despite the additional functions of the threaded spindle 2, the outer part 5 has a particularly simple geometry and can be supplied in a simple manner in the desired length by cutting it off from a longer tube provided with the thread 7, for example.

The embodiment example shown in FIG. 5 differs from the embodiment example shown in FIGS. 3 and 4 in that the inner sleeve 6 is of multi-part construction, namely being constructed from a first sleeve piece 14 and a second sleeve piece 15. In this case, the second sleeve piece 15, from which the end surface segment 10 is formed, is also connected to the outer part 5 by a press fit joint.

FIGS. 6 and 7 show an embodiment example of a threaded spindle 2 which differs from the design shown in FIGS. 1 and 2 in that the stop elements 9 are designed as tongues which are bent over in the axial direction and which partially overlap with the thread 7. The tongue-shaped stop elements 9 are suitable for interaction with a stop contour, denoted by 16, of the ball screw nut 3. Moreover, the stop elements 9 can also be used as anti-rotation elements with respect to a housing 4. In this case, the housing 4 has anti-rotation contours 17 shaped as recesses, in which the stop elements 9 can engage. In this case, the stop elements 9 can project partially from the anti-rotation contour 17, as illustrated in FIG. 10, and hence form a stop relative to the ball screw nut 3. If this stop function is not desired, there is the possibility of inserting the threaded spindle 2 so far into the housing 4 that the stop elements 9 no longer project from the anti-rotation contour 17, as illustrated in FIG. 11.

### LIST OF REFERENCE SIGNS

1 ball screw drive
2 threaded spindle, hollow spindle
3 ball screw nut
4 housing
5 outer part
6 inner sleeve
7 thread
8 collar
9 stop element
10 end surface segment
11 central aperture in the end surface segment
12 aperture in the circumference of the end surface segment, cable opening
13 toothing
14 first sleeve piece
15 second sleeve piece
16 stop contour of the ball screw nut
17 anti-rotation contour of the housing
18 flat
19 press fit surface

1. A ball screw drive, having a ball screw nut and a hollow threaded spindle, the hollow spindle being assembled from an outer part having a thread and an inner sleeve, the inner sleeve connected to the outer part without additional components and having a collar, which projects beyond the outer part at a first and on which at least one stop elements is formed, wherein the ball screw nut has a stop contour provided for interaction with the stop element.

2. The ball screw drive of claim 1, wherein the inner sleeve is connected to the outer part by a press fit joint.

3. The ball screw drive of claim 1, further comprising a housing, which has an anti-rotation contour provided for at least partial reception of the stop element.

4. The ball screw drive of claim 1, wherein the collar has toothing.

5. The ball screw drive of claim 1, wherein the inner sleeve has an end surface segment having a central aperture and a circumferential aperture adjoining the central aperture.

6. The ball screw drive of claim 1, wherein the inner sleeve is of multi-part construction.

7. The ball screw drive of claim 1, wherein the inner sleeve has a surface hardness less than a surface hardness of the thread of the outer part.

8. A hollow threaded spindle comprising:
an outer part having a thread; and
an inner sleeve press fit into the outer part, the inner sleeve having a collar projecting beyond the outer part at a first end, and at least one stop element being formed on the collar.

9. The hollow threaded spindle of claim 8, wherein the collar has toothing.

10. The hollow threaded spindle of claim 8, wherein the inner sleeve has an end surface segment at a second end opposite the first end, the end surface segment defining a central aperture and a circumferential aperture adjoining the central aperture.

11. The hollow threaded spindle of claim 8, wherein the inner sleeve is of multi-part construction.

12. The hollow threaded spindle of claim 8 wherein the inner sleeve has a surface hardness less than a surface hardness of the thread of the outer part.

13. A method of manufacturing a ball screw drive, the method comprising:
providing a threaded outer part;
providing a first inner sleeve having a collar at a first end, at least one stop element being formed on the collar; and
press fitting the first inner sleeve into the outer part such that the collar projects beyond and end of the outer part to form a spindle.

14. The method of claim 13 further comprising:
threading a ball screw nut onto the threaded outer part, the ball screw nut having a stop contour provided for interaction with the stop element.

15. The method of claim 13 further comprising:
inserting the spindle into a housing such that the stop element is received within an anti-rotation contour of the housing.

16. The method of claim 13 wherein the first inner sleeve has an end surface segment at a second end opposite the first end, the end surface segment defining a central aperture and a circumferential aperture adjoining the central aperture.

17. The method of claim 13 further comprising press fitting a second inner sleeve into the outer part, the second inner sleeve having an end surface segment defining a central aperture and a circumferential aperture adjoining the central aperture.

18. The method of claim 13 wherein the first inner sleeve has a surface hardness less than a surface hardness of the thread of the outer part.

19. The method of claim 13 wherein providing a threaded outer part comprises providing a threaded tube longer than the outer part and cutting the outer part from the threaded tube.
